(19) United States
(12) Patent Application Publication
(10) Pub. No.: US 2010/0146800 A1
(43) Pub. Date: Jun. 17, 2010

(54) Apparatus having a tool on an elongate pole and method of using the apparatus

(76) Inventors: Ron Carlson, Elgin, IL (US); Daniel De Lay, Muskego, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/316,474

(22) Filed: Dec. 12, 2008

(51) Int. Cl. B26B 27/00

(52) U.S. Cl. 30/296.1

(57) ABSTRACT

A method of using an apparatus having an elongate pole with a proximal region, a distal region, an intermediate region, and a tool at the distal region. The method includes the steps of: providing a harness with a support; placing the harness on a user so that the harness is maintained in an operative position on the user; releasably placing the apparatus in a holding position upon the support with the harness in the operative position wherein at least a part of the weight of the apparatus is borne by the support; controllably repositioning the tool by manipulating the elongated pole from a region spaced from the distal region; and performing an operation on an object through the tool.

### BACKGROUND OF THE INVENTION

1. Field of the Invention

This invention relates to hand operated apparatus with tools, such as brush trimmers, mounted on an elongate pole and, additionally, to a method of using such an apparatus.

2. Background Art

It is well known to provide apparatus with different tools mounted on elongate poles to allow the tools to be manually placed at hard-to-reach locations. The nature of such tools varies widely, as do the industries in which they are used.

As one example, it is known to cut limbs and other brush through the use of different cutting mechanisms that are mounted upon an elongate pole. In its simplest form, the elongate pole has a proximal end and a distal end. A cutting blade is mounted at the distal end. A user grasps and manipulates the proximal end of the elongate pole to strategically place the blade at the desired cutting location. Thereafter, the user repositions the elongate pole to effect the desired cutting action.

Powered cutting mechanisms have become increasingly popular. In a typical construction, a drive is provided at the proximal end of an elongate pole to cause operation of a cutting mechanism. The cutting mechanism may be a moving cutting chain, a reciprocating blade, or any of a multitude of other cutting mechanism designs that are currently available. These powered cutting mechanisms are operated in the same manner as the above-described manual mechanism. That is, the user elevates and repositions the cutting mechanism at the distal end of the elongate pole by grasping and manipulating the elongate pole from its proximal end.

Over the past decades, these powered cutting mechanisms have evolved significantly. Handles are incorporated to allow the apparatus to be comfortably held and repositioned. The elongate poles, while sometimes made with fixed lengths, are more commonly made with extendible lengths. This permits the users thereof to access areas that are significantly vertically spaced from where the user is standing and to have the flexibility to conveniently access intermediate heights.

Apparatus with pole mounted, powered, trimming tools for vegetation are becoming a staple for landscape and maintenance crews. These crews are often required to work an entire day using these apparatus. While the apparatus are being made with materials that make them generally light in weight, it is nonetheless common for the users thereof to become fatigued after supporting the apparatus in an elevated position throughout a work day. This fatigue may contribute to compromised workmanship and, in a worst case, injuries.

One solution to the fatigue problem is to periodically place the apparatus on a support, such as the ground. The user can rejuvenate his/her muscles preparatory to again beginning cutting/trimming operations. This repeated activity requires that the user lean down to raise and lower the apparatus, which activity, if repeated frequently, itself contributes to fatigue and joint and muscle stress.

Heretofore, the industry has contended with the above problems and has attempted to alleviate them by continuing to try and further reduce the overall weight of such apparatus. However, in spite of this effort, the powered units that incorporate gas, electric, or battery powered drives are of necessity of a weight that cannot ever be reduced to the point that prolonged user support thereof will not induce fatigue. Weight reduction is further complicated by the telescoping mechanisms that require the use of cooperating shafts and protective casings.

The industry continues to seek out ways to use apparatus with tools mounted on elongate poles in a safe manner with minimal burden to users thereof.

### SUMMARY OF THE INVENTION

In one form, the invention is directed to a method of using an apparatus having an elongate pole with a proximal region, a distal region, an intermediate region between the proximal and distal regions, and a tool at the distal region. The method includes the steps of: providing a harness with a support; placing the harness on a user so that the harness is maintained in an operative position on the user; releasably placing the apparatus in a holding position upon the support with the harness in the operative position wherein at least a part of the weight of the apparatus is borne by the support; controllably repositioning the tool by manipulating the elongate pole from a region spaced from the distal region; and performing an operation on an object through the tool.

In one form, the step of providing a harness involves providing a harness with a belt portion and the step of placing the harness in the operative position on a user involves wrapping the belt portion around the user's torso.

In one form, the step of providing a harness involves providing a harness with at least one shoulder strap and the step of placing the harness in the operative position on a user involves placing the at least one shoulder strap over at least one of the user's shoulders.

In one form, the step of providing a harness involves providing a harness with a support having an upwardly opening U-shaped receptacle into which the apparatus can be directed by translation selectively: a) from a separated position into the holding position; and b) from the holding position into the separated position.

In one form, the step of providing a harness involves providing a harness with a support having an upwardly opening U-shaped receptacle into which a length of the elongate pole seats with the apparatus in the holding position.

In one form, the step of providing a harness involves providing a harness with a support having a formed wire that defines an upwardly opening U-shaped receptacle in which the apparatus resides with the apparatus in the holding position.

In one form, the step of providing a harness involves providing a harness with a belt portion. The step of placing the harness in the operative position on a user involves wrapping the belt portion around the user's torso. The step of providing a harness further involves providing a harness with a support having an inverted U-shaped mount that has first and second legs that straddle the belt portion.

In one form, the step of providing a harness involves providing a harness with a support having an upwardly opening U-shaped receptacle into which the apparatus can be vertically translated.

In one form, the step of providing a harness involves providing a harness with a support having a single piece that defines the U-shaped receptacle and the U-shaped mount.

In one form, the step of providing a harness involves providing a harness with a support having a pad assembly which is mounted to the first leg and resides between the first leg and a user's torso with the harness in the operative position.

In one form, the step of providing a harness involves providing a harness with a pad assembly with a pocket into which the first leg is directed.

In one form, the step of providing a harness involves providing a harness with a support having a third leg that bounds the upwardly opening U-shaped receptacle in conjunction with the second leg.

In one form, the step of providing a harness involves providing a harness with a support that is separable from the belt portion.

In one form, the method further involves the steps of providing a tether with a length and connecting the tether to the support and a part of the harness so that with the support separated from the belt portion the support is confined relative to the part of the harness within a distance dictated by the length of the tether.

In one form, the apparatus has a tool with a cutting mechanism for vegetation.

In one form, the step of placing the apparatus in a holding position involves placing the apparatus in a holding position wherein the entire apparatus is elevated above a subjacent surface upon which the user is supported.

In one form, the step of controllably repositioning the tool involves controllably repositioning the tool by manipulating the elongate pole with the apparatus fully separated from the support.

In one form, the invention is directed to the combination of: a) an apparatus having an elongate pole with a proximal region, a distal region, an intermediate region between the proximal and distal regions, and a tool at the distal region; and b) a harness that can be maintained in an operative position on a user and having a support. The support defines an upwardly opening U-shaped receptacle into which a part of the apparatus is releasably directed with the apparatus in a holding position, wherein at least a part of the weight of the apparatus is borne by the support.

In one form, the harness has first and second shoulder straps that are configured to be placed against a user's shoulder with the harness in the operative position.

In one form, the harness has a belt portion that is configured to be wrapped around a user's torso with the harness in the operative position.

In one form, the support has an inverted U-shaped mount that has first and second legs that straddle the belt portion.

In one form, the combination further includes a pad assembly into which the first leg extends and that resides between the first leg and a user's torso with the harness in the operative position.

In one form, the support is selectively attached to and removed from the belt portion by relatively vertically translating the support and belt portion.

In one form, the apparatus has a drive motor at the proximal region of the elongate pole and a cutting mechanism for vegetation at the distal region of the elongate pole.

In one form, the cutting mechanism has a cutting chain that is driven by the drive motor.

In one form, there is a single piece that defines the upwardly opening U-shaped receptacle and the U-shaped mount.

In one form, the single piece is a formed wire.

In one form, a tether is connected between the support and a part of the harness.

### BRIEF DESCRIPTION OF THE DRAWINGS

FIG. 1 is a schematic representation of one form of harness, according to the present invention, that can be placed and maintained in an operative position on a user and which has a support for an apparatus with an elongate pole having a tool at a distal region thereon;

FIG. 2 is a further schematic representation of the apparatus in FIG. 1;

FIG. 3 is a perspective view of one specific form of the harness in FIG. 1 with the support in three different optional locations on a belt portion on the harness;

FIG. 4 is a reduced, perspective view of the harness in FIG. 3 in an operative position on a user and with one specific form of apparatus in a holding position on the support;

FIG. 5 is an enlarged, perspective view of the support separated from the remainder of the harness;

FIG. 6 is an enlarged, side elevation view of the support in FIG. 5;

FIG. 7 is a view as in FIG. 5 with a pad assembly provided over a leg on the support;

FIG. 8 is a reduced, elevation view of the apparatus in FIG. 4 in an elevated, balanced, holding position on the support;

FIG. 9 is a view as FIG. 8 wherein the apparatus in the holding position is supported cooperatively by the support and a subjacent surface;

FIG. 10 is a reduced, perspective view of a user performing a trimming operation with the apparatus in FIGS. 4, 8 and 9, with the apparatus fully separated from the support;

FIG. 11 is a view as in FIG. 10 wherein part of the weight of the apparatus is borne by the support during a trimming operation;

FIG. 12 is a flow diagram representation of a method of using an apparatus, as in FIGS. 4 and 8-11; and

FIG. 13 is a schematic representation of a modified form of apparatus and harness, according to the invention.

### DETAILED DESCRIPTION OF THE DRAWINGS

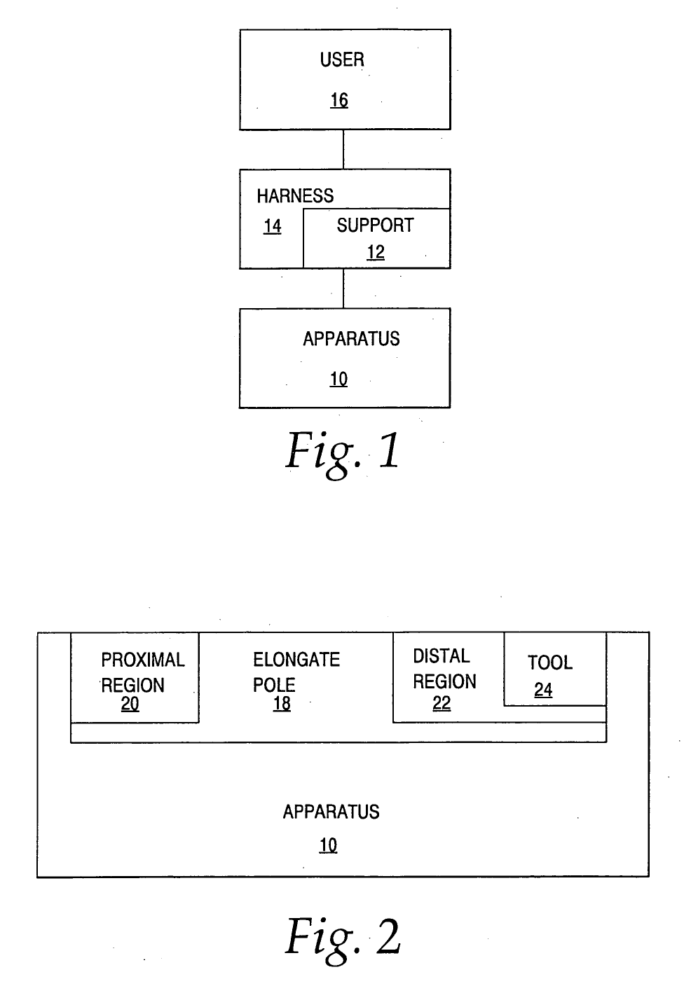

As seen in FIG. 1, the invention is directed to the combination of an apparatus 10, that can be releasably placed upon a support 12 on a harness 14 that is in turn releasably maintained in an operative position upon the body of a user 16. The apparatus 10 and harness 14 are shown in schematic form in FIG. 1 since they can take virtually an unlimited number of different forms, consistent with the present invention. With the structure shown, the apparatus 10 can be placed in a holding position on the support 12, whereby at least part of the apparatus 10 is elevated above a subjacent surface upon which a user 16 is situated. The support 12 bears at least a part of the weight of the apparatus 10 with the apparatus 10 in the holding position.

The precise nature of the apparatus 10 is not critical to the present invention. The harness 14 is particularly adaptable to being used with an apparatus 10, as shown in FIG. 2, with an elongate pole 18 with a proximal region 20 and a distal region 22 at which a tool 24 is provided.

The elongate pole 18 may have a fixed length or a variable length, with the latter made possible as by the use of telescoping parts. The proximal region 20 is engagable by a user to controllably reposition the tool 24 at the distal region 22 by manipulating the elongate pole 18 from a region spaced from the distal region 22, and preferably adjacent the proximal region 20.

The tool 24 may take virtually an unlimited number of different forms. In one form, the tool 24 is in the form of a cutting mechanism, as for vegetation. The cutting mechanism may be a fixed, serrated blade, or one or more driven components that may be in the form of a moving cutting chain, reciprocating cutting blades, or any other type of mechanism known to those skilled in this art.

The harness 14 may be defined by any structure that allows the support to be maintained on the body of the user 16 in a manner that with the apparatus 10 placed in the holding position upon the support 12, the weight forces from the apparatus 10 are transferred through the harness and distributed comfortably to the body of the user 16. The harness 14 may include a belt around the torso, one or more shoulder straps, and more preferably a combination thereof.

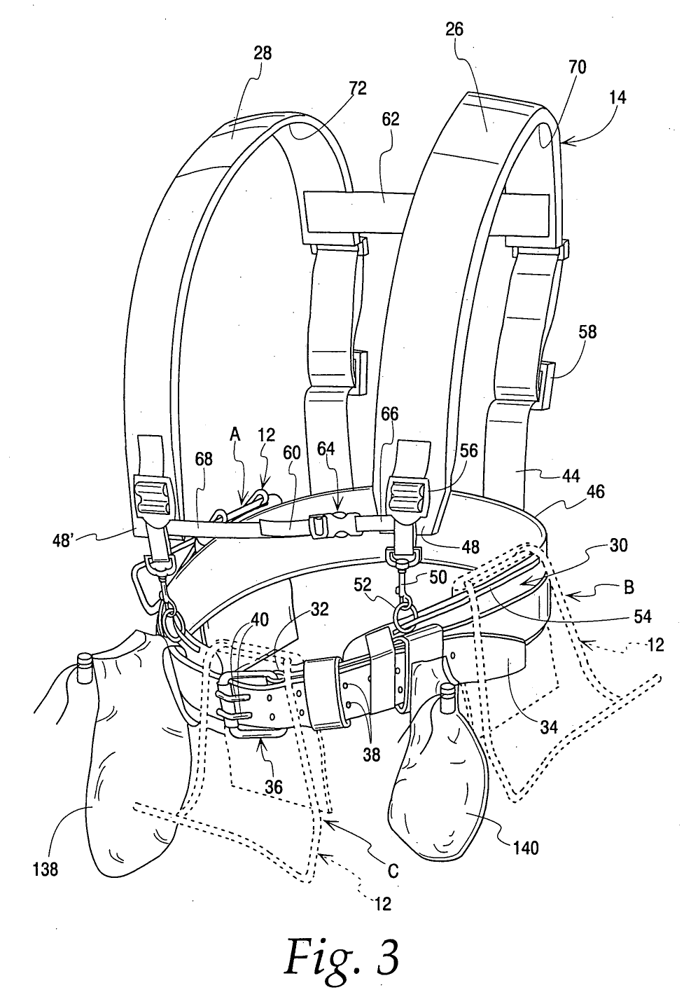

One preferred form of the harness 14 and an exemplary apparatus 10 are shown in FIGS. 3-11. It should be understood that this particular embodiment is but exemplary in nature as variations, within the schematic depiction of the components shown in FIGS. 1 and 2, are contemplated.

The harness 14 consists of first and second shoulder straps 26, 28, a belt portion 30, and the aforementioned support 12. The belt portion 30 has spaced ends 32, 34. The end 32 has a buckle 36 attached thereto through which the end 34 can be directed in conventional manner. The belt portion 30 has pairs of holes 38 at regularly spaced intervals to accept prongs 40 on the buckle 36, thereby to conventionally releasably fix a desired circumferential dimension for the belt portion 30 to accommodate different size users. The belt portion 30 is extended around the torso 42 of the user 16 and is secured ideally above the hip region of the user 16 as would be a conventional belt.

Exemplary shoulder strap 26 has a rear end 44 that is fixed at a rear surface 46 of the belt portion 30. The shoulder strap 26 extends from the rear end 44 to a front free end 48 at which a relaseable clip 50 is mounted. The clip 50 is releasably connected to a ring 52 that surrounds, and is slidable guidingly along, a flexible cord 54.

Conventional length adjustment mechanisms 56, 58 are respectively provided at the front and rear of the shoulder strap 26 to allow the effective length of the shoulder strap 26 to be adjusted to the dimensions of a particular user.

The shoulder strap 28 is identical in construction to the shoulder strap 26, though this is not a requirement.

The shoulder straps 26, 28 are joined by laterally extending spacing straps 60, 62, respectively at the front and rear of the harness 14. Each of the spacing straps 60, 62 may be length adjustable to thereby maintain a desired lateral spacing between the shoulder straps 26, 28. For the exemplary spacing strap 60, a conventional length adjustment mechanism 64 is shown which also allows the snap connection of separate strap portions 66, 68 that combine to produce the overall strap spacing length.

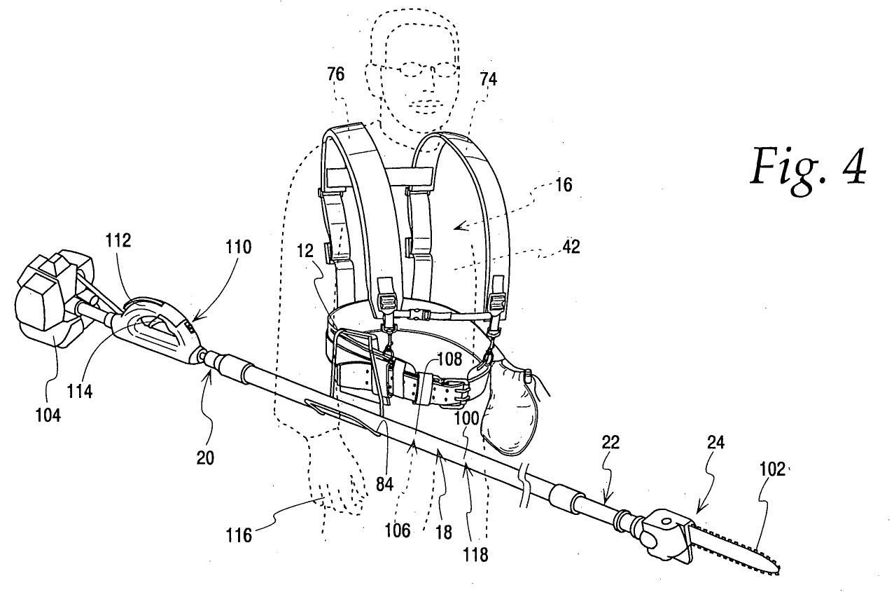

The user 16 can place the harness 14 in the operative position of FIG. 4 by either: a) preliminary releasing the front free end 48 of the strap 26 from the belt portion 30, and the corresponding front free end 48′ on the shoulder strap 28, and wrapping the belt portion 30 around the user's torso; b) or wrapping the belt portion 30 around the user's torso with the front free ends 48, 48′ remaining connected to the belt portion 30. The latter may be accomplished by directing the connected straps 26, 28 downwardly to against the user's shoulders with the belt portion ends 32, 34 disengaged. Appropriate adjustments can be made to the harness 14 to allow the same to comfortably sit in the operative position wherein the undersides 70, 72 of the shoulder straps 26, 28 bear upon the user's shoulders 74, 76, respectively, and the belt portion 30 wraps closely and comfortably around the user's torso.

The support 12 consists of at least one part that is joined to the harness 14. The support 12 can be permanently attached to the remainder of the harness 14 or connected in a manner to be selectively separable therefrom. The support 12 could be attached to any part of the harness 14, including the straps 26, 28, but is more preferably attached to the belt portion 30, as shown.

More particularly, the support 12 includes a body 78 made from a continuously formed wire. The body 78 has an inverted U-shaped mount 80 and a support portion 82. The support portion 82 defines an upwardly opening, U-shaped receptacle 84 into which the apparatus 10 can be placed in a holding position, as hereinafter described.

The U-shaped mount 80 consists of a first leg 86 and a second leg 88 joined by a bight portion 90. A U-shaped receptacle 92 opens downwardly and is designed to accept the belt portion 30 at virtually any circumferential location around the user's torso with the harness 14 in the operative position.

More particularly, as shown in FIG. 6, from a separated position, the support 12 can be translated vertically downwardly relative to the belt portion 30 into an assembled position wherein the first and second legs 86, 88 straddle the belt portion 30 and the top edge 94 of the belt portion 30 resides against or adjacent to the bight portion 90. Through this arrangement, the U-shaped mount 80 is capable of being separably hooked on to the belt portion 30, whereupon the U-shaped receptacle 84 opens upwardly to accommodate a part of the apparatus 10. In this embodiment, the receptacle 84 is defined cooperatively by the second leg 88 and a third leg 96 joined with the second leg 88 at a bight portion 98.

The U-shaped receptacle 84 is preferably configured to accept a portion of the apparatus 10, in this case a portion of the elongate pole 18, that is translated vertically downwardly relative thereto from a separated position at A in FIG. 6 into the holding position at B in that same Figure, wherein the apparatus 10 bears upon the support 12 within the receptacle 84. The apparatus 10 is separable from the support 12 by movement relative thereto through a reversed translational movement. It is conceivable that the support 12, or a like support, could be attached to, and thus made part of the apparatus 10, to be attached to and separated from the harness 14 by like translational movement.

The exemplary apparatus 10, as shown in FIG. 4, has an elongate pole 18 with a telescoping body 100, as shown in U.S. Pat. No. 4,654,971, which is incorporated herein by reference. In this embodiment, the tool 24 at the distal region 22 of the elongate pole 18 has a cutting chain 102 that moves in an endless path. The cutting chain 102 is driven by a motor 104 that is at the proximal region 20 and may be gas or electrically powered. Through a shaft assembly 106 within an outer casing 108, a drive force from the motor 104 is transmitted to the cutting chain 102.

A handle assembly 110 at the proximal region 20 defines a grip 112 that can be grasped to support and control repositioning of the elongate pole 18 and the tool 24 thereon. The handle assembly 110 also has a throttle control 114 that can be repositioned by a user's finger(s) 116 on the hand that is surrounding the grip 112.

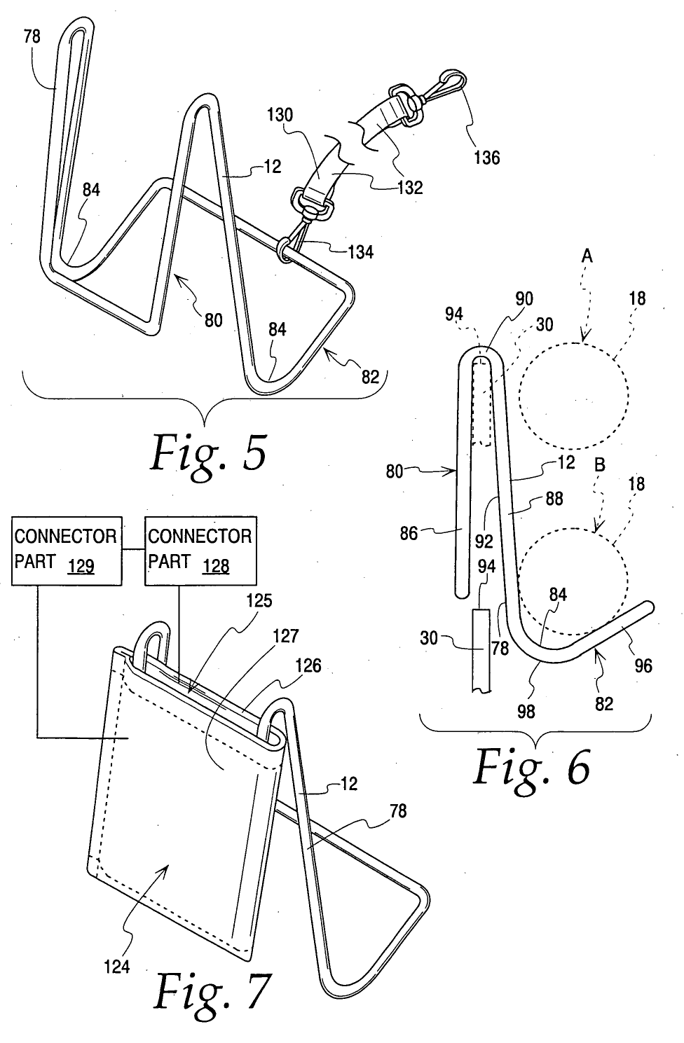

The receptacle 84 is configured to accept and support a length of the elongate pole 18 in a holding position, as shown in FIGS. 5 and 6. Any portion along the extent of the elongate pole 18, at the proximal region 20, the distal region 22, or an intermediate region at 118 between the proximal and distal regions 20, 22, can be placed in the receptacle 84 so that the support 12 thereby bears part or all of the weight of the apparatus 10.

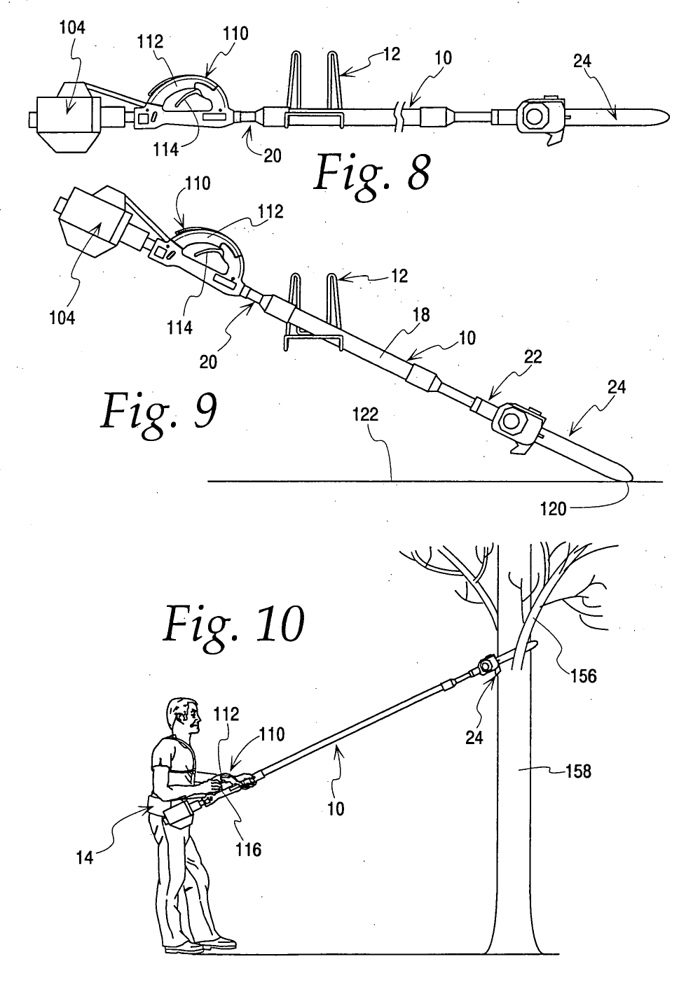

In one preferred form, as shown in FIGS. 4 and 8, the apparatus 10 is placed in the receptacle 84 so that the weight thereof is borne by the support 12 with the weight of the apparatus 10 projecting oppositely from the support 12 substantially the same so that the apparatus 10 balances on the support 12 without any significant application of a force by the user 16 thereon.

In most instances, the support 12 is most conveniently used on one side or the other of the belt portion 30, as shown at A in solid lines and at B in dotted lines in FIG. 3, whereupon the length of the elongate pole 18 projects in a front-to-rear direction with respect to the user 16. Alternatively, with the support 12 situated as shown in dotted lines at C in FIG. 3, the length of the elongate pole 18 with the apparatus 10 in the holding position therefor projects laterally with respect to the user 16 in front of him/her.

It is also possible, as shown in FIG. 9, that an end of the apparatus 10, in this case the end 120 at the distal region 22 of the elongate pole 18, might be rested upon a subjacent surface 122 upon which the user is standing while resting/bracing the elongate pole 18 on the support 12.

With the support 12 made from formed wire as shown, or other hard material, the weight of the apparatus 10 in the receptacle 84 may bear the first support leg 86 against the user's body and thereby cause discomfort. To avoid this problem, an optional pad assembly, as shown at 124 in FIG. 7, is employed. The pad assembly 124 is made from a cushioning material and defines a pocket 125 into which the first leg 86 can be directed, whereupon a padded wall 126 on the pad assembly 124 resides between the first leg 86 and the user's body. The wall 126 and a spaced wall 127, also bounding the pocket 125, may be releasably connected together as by cooperating connector parts 128, 129, thereby to maintain the pad assembly 124 on the support 18. The connector parts 128, 129 may be cooperating snap parts, hook and loop fastener components, etc. The pad assembly 124 functions regardless of where the support 12 is mounted on the belt portion 30.

In the event that the support 12 is designed to be fully separable from the remainder of the harness 14, a tether 130, as shown in FIG. 5 may be used. The tether 130 has a flexible strap 132 with a length between releasable hooks 134, 136 that are respectively attached to the support 12 and a part of the remaining portion of the harness 14. The strap 132 confines movement of the support 12 relative to the part of the harness 14 to within a range dictated by the length of the tether 130.

The harness 14, in addition to mounting the support 12, also serves as a foundation for the placement of other accessories, such as parts receptacles 138, 140, as shown in FIGS. 3 and 4. Other accessories can be mounted upon the belt portion 30 and/or on the straps 26, 28.

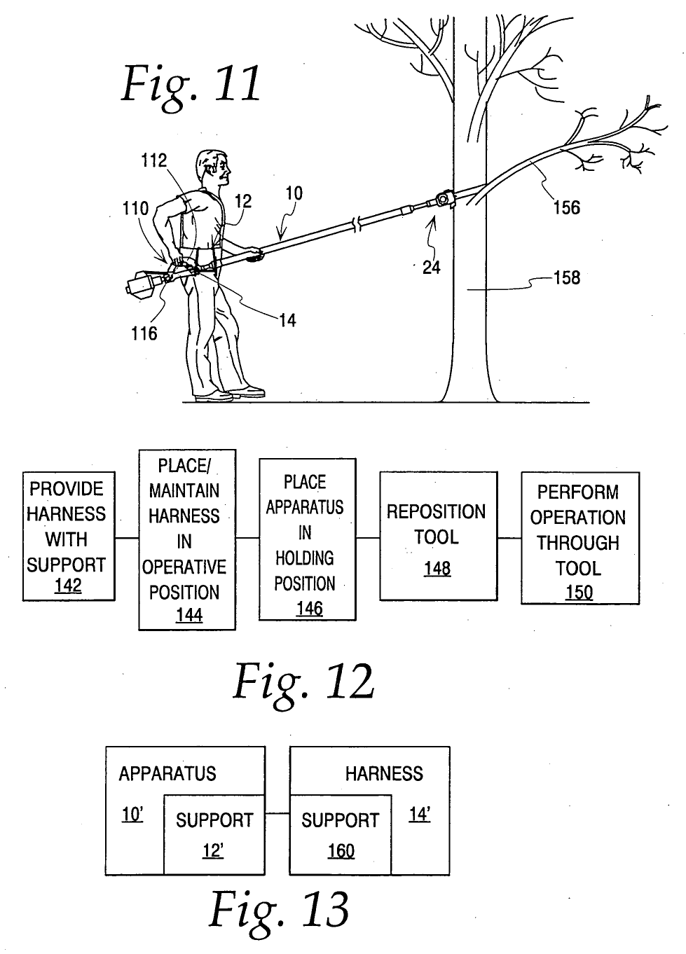

With the structure as described above, the apparatus can be used as shown in flow diagram form in FIG. 12. As shown at block 142, the harness 14 with the support 12 is provided. As noted above, the support 12 may be part of the harness 14 or the apparatus 10. The method will be described with respect to FIG. 12 with the former construction. As shown at block 144, the harness is placed and maintained in the operative position upon the user. As shown at block 146, the apparatus 10 is placed in a holding position on the support 12, whereby the apparatus 10 remains fully elevated above the subjacent surface upon which the user is standing, as shown in FIGS. 8 and 11, or in a manner as shown in FIG. 9, wherein the apparatus 10 bridges between the support 12 and a subjacent surface. As shown at block 148, the tool 24 is controllably repositioned by manipulating the elongate pole 18 from a region spaced from the distal region 22. As shown at block 150, an operation is performed on an object through the tool 24. It is possible to reposition the tool 24 through manipulation of the elongate pole 18 with the apparatus 10 fully separated from the support 12, as shown in FIG. 10, or with the apparatus 10 resting upon the support 12, as shown in FIG. 11. In these Figures, the apparatus 10 is shown, in an exemplary operation, used to trim a branch 156 on a tree/foliage 158.

By placing the apparatus against the support 12, the user 16 is allowed to keep the apparatus 10 in a “ready” position for use. The support 12 allows the apparatus 10 to be in an elevated or “ready” position with limited or no lifting force applied by the user 16. This allows the user to elevate/transport the apparatus 10 between jobs and elevate the same between steps in a particular operation without suffering from excessive muscular fatigue, as may otherwise result from constantly holding the apparatus 10 in a fully or partially elevated position. At the same time, the user is not required to lower the apparatus 10 to a subjacent surface and re-elevate the same, as to rest between operations or during an operation.

The invention contemplates numerous variations from the above-described structure. As but one example, as noted above, the element 12, or like element, may be made part of the apparatus 10, whereupon the harness has another component that functions as the described support. More specifically, as shown in FIG. 13, an element 12′, corresponding to the support 12, may be integrated with the apparatus 10′, to cooperate with a separate support 160 on the harness 14′. The connection between the apparatus 10′ and support 160, to releasably place the apparatus 10′ in a holding position upon the support 160, is preferably effected by simple relative movement such as translational movement. Separation is preferably effected in a like, reversed manner.

The foregoing disclosure of specific embodiments is intended to be illustrative of the broad concepts comprehended by the invention.

1. A method of using an apparatus comprising an elongate pole with a proximal region, a distal region, an intermediate region between the proximal and distal regions, and a tool at the distal region, the method comprising the steps of:
providing a harness with a support;
placing the harness on a user so that the harness is maintained in an operative position on the user;
releasably placing the apparatus in a holding position upon the support with the harness in the operative position wherein at least a part of the weight of the apparatus is borne by the support;
controllably repositioning the tool by manipulating the elongate pole from a region spaced from the distal region; and
performing an operation on an object through the tool.

2. The method of using an apparatus according to claim 1 wherein the step of providing a harness comprises providing a harness with a belt portion and the step of placing the harness in the operative position on a user comprises wrapping the belt portion around the user's torso.

3. The method of using an apparatus according to claim 1 wherein the step of providing a harness comprises providing a harness with at least one shoulder strap and the step of placing the harness in the operative position on a user comprises placing the at least one shoulder strap over at least one of the user's shoulders.

4. The method of using an apparatus according to claim 1 wherein the step of providing a harness comprises providing a harness with a support comprising an upwardly opening U-shaped receptacle into which the apparatus can be directed by translation selectively: a) from a separated position into the holding position; and b) from the holding position into the separated position.

5. The method of using an apparatus according to claim 1 wherein the step of providing a harness comprises providing a harness with a support comprising an upwardly opening U-shaped receptacle into which a length of the elongate pole seats with the apparatus in the holding position.

6. The method of using an apparatus according to claim 1 wherein the step of providing a harness comprises providing a harness with a support comprising a formed wire that defines an upwardly opening U-shaped receptacle in which the apparatus resides with the apparatus in the holding position.

7. The method of using an apparatus according to claim 6 wherein the step of providing a harness comprises providing a harness with a belt portion, the step of placing the harness in the operative position on a user comprises wrapping the belt portion around a user's torso, and the step of providing a harness further comprises providing a harness with a support comprising an inverted U-shaped mount that has first and second legs that straddle the belt portion.

8. The method of using an apparatus according to claim 7 wherein the step of providing a harness comprises providing a harness with a support comprising an upwardly opening U-shaped receptacle into which the apparatus can be vertically translated.

9. The method of using an apparatus according to claim 7 wherein the step of providing a harness comprises providing a harness with a support comprising a single piece that defines the U-shaped receptacle and the U-shaped mount.

10. The method of using an apparatus according to claim 7 wherein the step of providing a harness comprises providing a harness with a support comprising a pad assembly which is mounted to the first leg and resides between the first leg and a user's torso with the harness in the operative position.

11. The method of using an apparatus according to claim 10 wherein the step of providing a harness comprises providing a harness with a pad assembly with a pocket into which the first leg is directed.

12. The method of using an apparatus according to claim 7 wherein the step of providing a harness comprises providing a harness with a support comprising a third leg that bounds the upwardly opening U-shaped receptacle in conjunction with the second leg.

13. The method of using an apparatus according to claim 7 wherein the step of providing a harness comprises providing a harness with a support that is separable from the belt portion.

14. The method of using an apparatus according to claim 13 further comprising the steps of providing a tether with a length and connecting the tether to the support and a part of the harness so that with the support separated from the belt portion the support is confined relative to the part of the harness within a distance dictated by the length of the tether.

15. The method of using an apparatus according to claim 1 wherein the apparatus comprises a tool with a cutting mechanism for vegetation.

16. The method of using an apparatus according to claim 1 wherein the step of placing the apparatus in a holding position comprises placing the apparatus in a holding position wherein the entire apparatus is elevated above a subjacent surface upon which the user is supported.

17. The method of using an apparatus according to claim 1 wherein the step of controllably repositioning the tool comprises controllably repositioning the tool by manipulating the elongate pole with the apparatus fully separated from the support.

18. In combination:
a) an apparatus comprising an elongate pole with a proximal region, a distal region, an intermediate region between the proximal and distal regions, and a tool at the distal region; and
b) a harness that can be maintained in an operative position on a user and comprising a support,
the support defining an upwardly opening U-shaped receptacle into which a part of the apparatus is releasably directed with the apparatus in a holding position wherein at least a part of the weight of the apparatus is borne by the support.

19. The combination according to claim 18 wherein the harness comprises first and second shoulder straps that are configured to be placed against a user's shoulder with the harness in the operative position.

20. The combination according to claim 19 wherein the harness comprises a belt portion that is configured to be wrapped around a user's torso with the harness in the operative position.

21. The combination according to claim 20 wherein the support comprises an inverted U-shaped mount that has first and second legs that straddle the belt portion.

22. The combination according to claim 21 wherein the harness further comprises a pad assembly into which the first leg extends and that resides between the first leg and a user's torso with the harness in the operative position.

23. The combination according to claim 20 wherein the support is selectively attached to and removed from the belt portion by relatively vertically translating the support and belt portion.

24. The combination according to claim 20 wherein the apparatus comprises a drive motor at the proximal region of the elongate pole and a cutting mechanism for vegetation at the distal region of the elongate pole.

25. The combination according to claim 24 wherein the cutting mechanism comprises a cutting chain that is driven by the drive motor.

26. The combination according to claim 21 wherein there is a single piece that defines the upwardly opening U-shaped receptacle and the U-shaped mount.

27. The combination according to claim 26 wherein the single piece comprises a formed wire.

28. The combination according to claim 23 further comprising a tether that is connected between the support and a part of the harness.
